(19) United States
(12) Patent Application Publication
(10) Pub. No.: US 2004/0204850 A1
(43) Pub. Date: Oct. 14, 2004

(54) Automotive synchronized communication networks

(75) Inventors: Perry Robinson MacNeille, Lathrup Village, MI (US); Ronald Hugh Miller, Saline, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Motor Company, Dearborn, MI (US)

(21) Appl. No.: 09/683,948

(22) Filed: Mar. 6, 2002

(51) Int. Cl. G01C 21/36

(52) U.S. Cl. 701/213; 342/357.09; 455/41.2

(57) ABSTRACT

Frequency hopping spread spectrum transceivers in an automotive communication system are synchronized using timing information extracted from GPS satellites. A GPS receiver in each vehicle generates a pulse per second (PPS) signal. The FHSS transceiver in each vehicle communicates with a plurality of FHSS transceivers in other vehicles. Control logic synchronizes discovery of at least one FHSS transceiver in another automotive vehicle based on the PPS signal. Switching between piconets is also synchronized by the PPS signal.

### BACKGROUND OF INVENTION

1. Field of the Invention

The present invention relates to data communication between stationary or moving automotive vehicles.

2. Background Art

Automotive vehicles may be provided with intelligence and sensors to perform a wide variety of tasks. Many of these tasks are enabled or enhanced by communicating with surrounding vehicles. Typical applications include collision avoidance; autonomous, hands free or limited involvement driving; and notification of conditions such as accidents, construction, emergency vehicles, traffic loads, changing weather patterns, and the like.

One means for establishing communications that could be adapted to use in vehicles is frequency hopping spread spectrum (FHSS) transmission. FHSS transponders hop from frequency channel to frequency channel within a designated frequency band following mutually agreed upon patterns and times. Generally, FHSS communication is bidirectional, one-to-one, or one-to-many and is often combined with an error correction-detection scheme such as forward error correction. Thus, data lost on one hop is detected and retransmitted in another hop. Communication is typically unbalanced, with a single master transceiver synchronizing several slave transceivers. A single master and its slaves form a piconet with a unique hopping sequence. Multiple piconets with overlapping ranges can communicate independently on different hopping sequences. Piconets can be joined into multi-hop networks such as, for example, scatternets when a slave device in one piconet is simultaneously a master or slave in another piconet.

FHSS transmission is power efficient because, at any given time, transceivers are transmitting on the narrowest band possible. This permits good signal to noise ratios using inexpensive equipment. FHSS transceivers may also be made compact enough to be combined with a CPU on a single integrated circuit. One example of an FHSS standard is the Bluetooth or IEEE 802.15 specification. Another is IEEE 802.11 which specifies frequency hopping in the ISM band.

A difficulty with FHSS communication is that the transmitter and receiver(s) must be synchronized. Generally, before synchronization there is agreement between the two devices as to what frequencies they will use, the time duration (hop interval) each frequency will be used and a set of frequency hopping patterns. The time duration is normally fixed, but may also vary following fixed rules. In the case of Bluetooth the hop interval is generally 0.625 msec and the symbol time 1 μsec. Synchronization typically takes place in two steps: course synchronization in which the two devices are synchronized to within a fraction of a hop interval, and fine synchronization in which the two devices are synchronized to within the time needed to transmit a symbol. Course synchronization can take a matter of seconds or even minutes to accomplish, and must be completed before the two devices can become aware of each other. This process of synchronization is frequently called discovery because it involves finding other devices that may or may not be present. If devices are present, discovery requires an unknown amount of time to find them.

A related problem is that, for course synchronization to take place, one system needs to be a transmitter and the other a receiver. Before the systems are aware of each other, each system has no prior way of knowing whether it should function as a transmitter or a receiver.

Inter-vehicle communications pose several challenges for FHSS transceiver systems. Discovery and abandonment processes are required as vehicles move into and out of range. Typically, as a new vehicle comes into range, transceivers in each vehicle must discover the other vehicle transceiver, decide which transceiver will be master and which will be slave, synchronize the clocks of the transceivers, and select a hopping sequence. For example, vehicles that approach each other at 110 km/hr and have transceivers with 300 meter ranges have about four seconds in which to accomplish these tasks. These operations typically must be accomplished while the transceivers complete other tasks such as, for example, communicating with other transceivers in one or more piconets.

For scatternet functionality, transceivers must be capable of belonging to multiple piconets to support the dynamic environment of traveling vehicles. Thus, a vehicle transceiver typically timeshares between piconets. Switching between piconets can be very inefficient if the hop intervals for each vehicle are not synchronized. Each time a transceiver shifts from one piconet to another, the transceiver must wait one or more hop cycles to synchronize with the next piconet. Further, it is necessary for each transceiver in the scatternet to remember the offset between its internal clock and the hopping pattern of each piconet with which it is time sharing. This offset changes with time due to clock drift between the piconets, making the clock offsets perishable. An FHSS device that is swapping between piconets must, therefore, repeat fine synchronization frequently to make sure the clock offsets are fresh. Failure to maintain fresh clock offsets would require course resynchronization to swap into a piconet whose timing information has become stale.

### SUMMARY OF INVENTION

The present invention synchronizes FHSS transceivers in an automotive communication system using timing information extracted from global positioning satellite (GPS) systems.

A communication system for an automotive vehicle is provided. The system includes a GPS receiver generating a pulse per second (PPS) or similar GPS timing signal. The system also includes an FHSS transceiver in communication with the GPS receiver. The FHSS transceiver communicates with a plurality of FHSS transceivers in other automotive vehicles. Control logic synchronizes discovery of at least one FHSS transceiver in another automotive vehicle using the GPS timing pulse.

In an embodiment of the present invention, the control logic forms a first piconet with a first subset of the other vehicle transceivers and a second piconet with a second subset of transceivers in other automotive vehicles. The control logic synchronously switches between communicating in the first piconet and communicating in the second piconet based on the PPS signal.

In another embodiment of the present invention, the FHSS transceiver is a Bluetooth transceiver. Bluetooth radios discover each other when two Bluetooth devices are in an inquiry state. One radio must be in inquiry scan mode, and the other radio in inquiry page mode. The device that is in scan-mode listens to a single hop frequency while the device in page-mode transmits short inquiry signals at different frequencies. When the device in page-mode transmits at the same frequency the device in scan-mode is listening, the devices begin to synchronize. The process can take more than 10 seconds. Discovery will not take place if the devices are in the same mode, so the devices must switch modes after a time interval so that they will be in opposite modes at least some of the time. Without GPS synchronization, the fraction of time in which the two devices are in opposite modes can be anywhere from zero to one. With GPS synchronization, a pattern can be set up so that the fraction of time the two devices are in opposite modes is close to 0.5. During the time a Bluetooth device is in an inquiry state it cannot participate in a piconet. Frequently, such a device may have to time share between piconet participation and discovery. Thus, it is much more effective to have all Bluetooth devices in inquiry mode at the same time. GPS synchronization accomplishes this because PPS pulses are synchronized on all devices.

A method of communication between automotive vehicles is also provided. Each of a plurality of vehicles receives GPS signals from a plurality of global positioning satellites. A PPS signal is determined in each of the vehicles based on the GPS signals. In at least one of the vehicles, a frequency hopping pattern is determined for transmitting inquiry packets. The inquiry packets are transmitted based on the frequency hopping pattern and on the PPS signal. Vehicles listen for inquiry packets at a plurality of discovery times based on the PPS signal. A network is established between the vehicle transmitting inquiry packets and at least one vehicle receiving the inquiry packets.

An automotive communication system for communicating information between automotive vehicles is also provided. The system includes at least one scatternet. Each scatternet includes a plurality of piconets. Each piconet includes a plurality of vehicles, each vehicle having an FHSS transceiver receiving a synchronizing PPS signal derived from a global positioning system. Each FHSS transceiver in the automotive communication system is synchronized with every other FHSS transceiver in the automotive communication system by the PPS signal.

The above objects and other objects, features, and advantages of the present invention are readily apparent from the following detailed description of the best modes for carrying out the invention when taken in connection with the accompanying drawings.

### BRIEF DESCRIPTION OF DRAWINGS

FIG. 1 is a block diagram illustrating an FHSS transceiver system;

FIG. 2 is a schematic diagram illustrating a scatternet which may be implemented by an automotive communication system according to an embodiment of the present invention;

FIG. 3 is a timing diagram illustrating prior art transceiver discovery;

FIG. 4 is a schematic diagram illustrating autonomous vehicle operation;

FIG. 5 is a timing diagram illustrating prior piconet switching according to an embodiment of the present invention;

FIG. 6 is a block diagram illustrating an FHSS transceiver system according to an embodiment of the present invention;

FIG. 7 is a timing diagram illustrating transceiver discovery according to an embodiment of the present invention;

FIG. 8 is a timing diagram illustrating piconet switching according to an embodiment of the present invention; and

FIG. 9 is a timing diagram illustrating piconet time division multiplexing according to an embodiment of the present invention.

### DETAILED DESCRIPTION

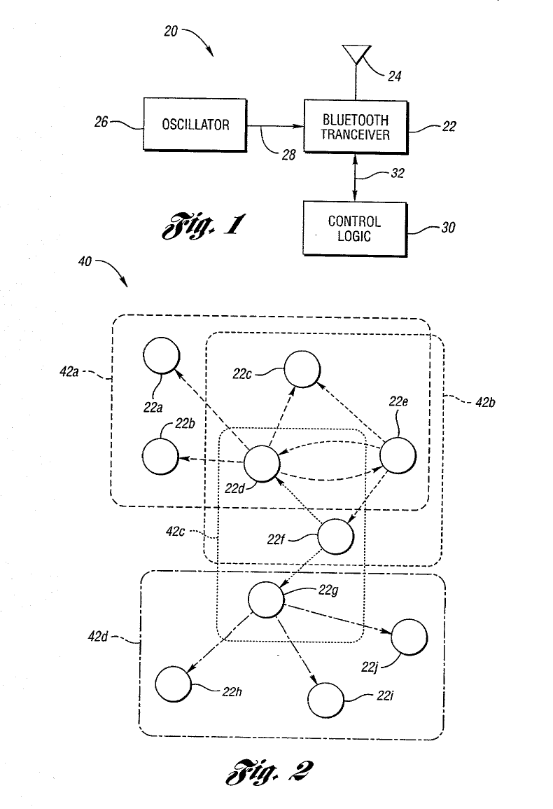

Referring to FIG. 1, a block diagram illustrating an FHSS transceiver system according to an embodiment of the present invention is shown. An FHSS transceiver system, shown generally by 20, includes FHSS transceiver 22 sending and receiving signals via antenna 24. Oscillator 26 provides timing reference signal 28 to FHSS transceiver 22. Typically, oscillator 26 is an inexpensive crystal-controlled oscillator prone to frequency drift. Control logic 30 communicates commands to FHSS transceiver 22 over link 32. Control logic 30 may also transmit and receive base band data via link 32.

FHSS transceiver 22 may implement the Bluetooth specification which defines a medium range radio link capable of data transmission to a maximum capacity of 720 kbps per channel with a range of around 100 m. Radio frequency operation is in the unlicensed industrial, scientific and medical (ISM) band at 2.4 to 2.48 GHZ. The Bluetooth specification calls for spread spectrum, frequency hopping, full-duplex signals at up to 1600 hops/sec. The United States specification indicates hops among 79 frequencies at 1 MHZ intervals, providing a high degree of immunity to interference. This specification enables single-chip implementation in CMOS circuitry resulting in reduced cost, power consumption and chip size for implementation in mobile devices.

Referring now to FIG. 2, a schematic diagram illustrating a scatternet which may be implemented by an automotive communication system according to an embodiment of the present invention is shown. A scatternet, shown generally by 40, interconnects a plurality of FHSS transceivers 22a-22j arranged as four piconets 42a-42d. Piconet 42a has master transceiver 22d and slave transceivers 22a, 22b, 22c and 22d. Piconet 42b has master transceiver 22e and slave transceivers 22c, 22d and 22f. Piconet 42c has master transceiver 22f and slave transceivers 22d and 22g. Piconet 42d has master transceiver 22g and slave transceivers 22h, 22i and 22j.

The Bluetooth specification provides for piconets 42 having a master transceiver 22 and up to seven simultaneously active slave transceivers 22. Slaves can participate in different piconets 42 and a master of one piconet 42 can be a slave in another piconet 42. In information dissipation systems, each slave transceiver 22 transmits to master transceiver 22 and master transceiver 22 broadcasts this information to all slave transceivers 22 within piconet 42.

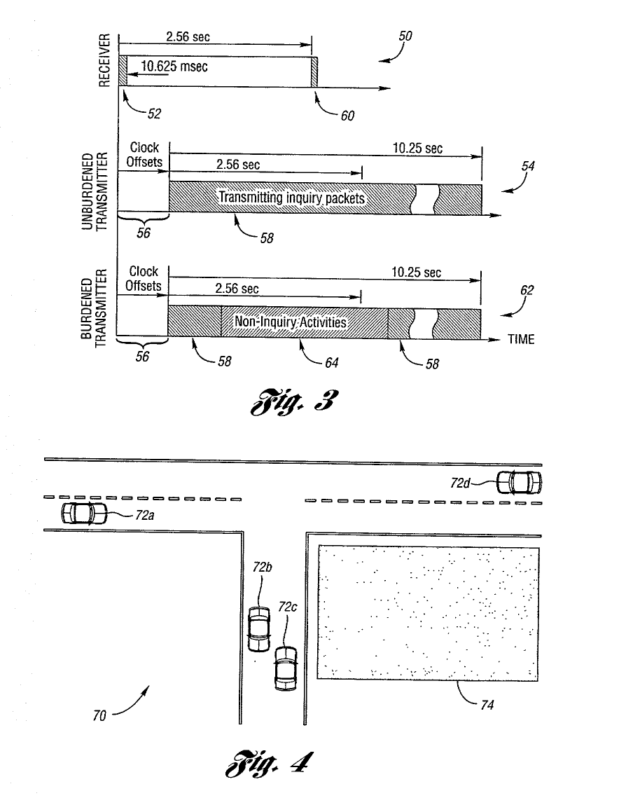

Referring now to FIG. 3, a timing diagram illustrating prior art transceiver discovery is shown. Receiver timing plot 50 illustrates operation of transceiver 22 in a listening mode. Listening period 52 represents when receiving transceiver 22 is listening for inquiry packets sent by transmitting transceiver 22. Typically, listening period 52 is 10.625 msec out of every 2.56 period. Unburdened transmitter timing plot 54 illustrates transceiver 22 dedicated solely to transmitting inquiry packets. Due to unsynchronized clocks between receiver and transmitter transceivers 22, transmitter transceiver 22 experiences clock offset time 56 relative to receiver transmitter system 22. Transmitting transceiver 22 then enters inquiry scan time 58 in which transmitting transceiver 22 sends very short packets on different channels. Receiving transceiver 22 listens periodically to a single channel. Inquiry packet received time 60 indicates a period in which receiver transceiver 22 receives an inquiry packet on the channel it is listening to sent by transmitting transceiver 22. This is known as discovery. The time needed after inquiry 58 begins to when discovery 60 occurs may be relatively large. Typically, 10.25 seconds is allowed for discovery with an unburdened transmitter.

The lengthy discovery problem is exacerbated if transmitting transceiver 22 is burdened with other communication tasks such as, for example, communicating with other transceivers 22 in piconet 42. As illustrated in burdened transmitter timing plot 62, non-inquiry time 64 dedicated to non-inquiry communication activities may occur during listening periods 52 of receiving transceiver 22. Thus, the time needed for discovery may be further extended.

Referring now to FIG. 4, a schematic diagram illustrating autonomous vehicle operation is shown. An automotive communication system, shown generally by 70, may include a plurality of vehicles 72. Each vehicle 72 may be an autonomous vehicle supporting a plurality of systems. Vehicle navigation systems provide vehicle location, velocity, bearing and the like. Transponder systems provide target identification, range, velocity, and the like. Radar systems provide target range, bearing, velocity, and the like. Optical systems provide object identification, range, bearing, and the like. Signaling systems communicate driver intent and include signal lights, brake lights, and the like. Transponder systems communicate vehicle identification. Transceiver systems 20 establish dialog between vehicles 72.

In the example shown, vehicles 72c and 72d are on a collision path but cannot determine the danger on their own due to obstruction 74 which may be, for example, a large building. Thus, by the time vehicles 72c and 72d clear the corner of obstruction 74, an insufficient amount of time remains for either vehicle to discover the other. The problem may be solved if vehicle 72a gets a range fix on vehicle 72d by, for example, using the transponder beacon of vehicle 72d. Vehicle 72a can locate vehicle 72d on the road using geographical information. Vehicle 72a then transmits the location of vehicle 72d to vehicle 72b, which forwards the information to vehicle 72c. However, if another obstruction 74 prevents vehicle 72a from communicating with vehicles 72b and 72c, the problem caused by extensive discovery time still exists.

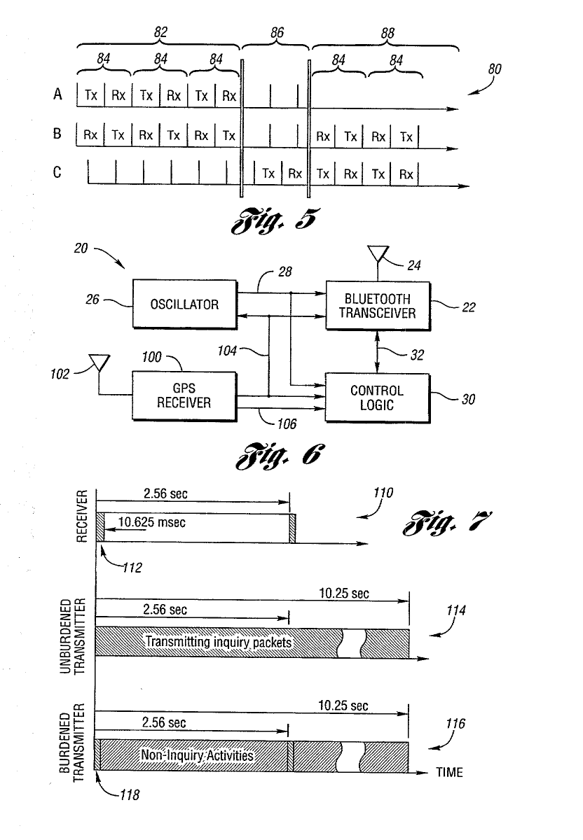

Referring now to FIG. 5, a timing diagram illustrating prior art piconet switching is shown. In addition to potentially long discovery times for new transceiver 22 joining piconet 42, another problem with existing FHSS communication systems is the time required for each transceiver 22 to switch between piconets 42. This problem is illustrated by timing plot 80. Two transceivers 22, indicated by A and B, are communicating within a first piconet 42 during time 82. In each hop 84, transceiver A first transmits while transceiver B synchronously listens. The process is reversed and transceiver B transmits while transceiver A synchronously listens. Eventually, transceiver B wishes to communicate with transceiver C in a second piconet 42. Transceiver B spends synchronization time 86 attempting to synchronize with transceiver C. Synchronization time 86 may be up to 2.5 milliseconds for Bluetooth. Once synchronized, transceivers B and C synchronously communicate during time 88.

Referring now to FIG. 6, a block diagram illustrating an FHSS transceiver system according to an embodiment of the present invention is shown. FHSS transceiver system 20 includes FHSS transceiver 22 which may be, for example, a Bluetooth transceiver. Transceiver 22 communicates with other FHSS transceivers 22 through antenna 24. Oscillator 26 provides timing reference signal 28 to FHSS transceiver 22. Control logic 30 communicates with FHSS transceiver 22 through link 32.

FHSS transceiver system 20 includes GPS receiver 100 which compares the arrival times of signals received on antenna 102 from a plurality of satellites in space whose positions are known to a high level of accuracy. The arrival times are used to compute the location of antenna 102 in three dimensions and in time. The time value computed by a typical, low cost GPS receiver 1 00 using course acquisition is accurate to about 200 nanoseconds. Thus, all GPS receivers 100 located anywhere on earth are synchronized in time. GPS receiver 100 generates universal coordinated time (UTC) signal 106 which provides the exact time of day. GPS receiver 100 also generates a GPS timing signal, such as pulse per second (PPS) signal 104, which provides an accurate clock tick every second. Without loss of generality, the term pulse per second signal includes a variety of GPS timing signals including signals with output pulses at 0.1 second intervals, 0.01 second intervals, and the like.

PPS signal 104 may be used to adjust the output of oscillator 26 such as, for example, through the use of a phase lock loop. Link 32 may be used by control logic 30 to periodically set the clock memory in FHSS transceiver 22 based on PPS signal Ef 104. FHSS transceiver 22 may be modified to have a duty cycle based on PPS signal 104. For example, the one second interval between PPS pulses may be divided into five sections. These sections may be synchronized by hardware and software of control logic 20 using PPS signal 104 and timing reference signal 28 to further divide each section. Each section may begin with an inquiry phase of about 50 milliseconds in which master units transmit inquiry signals and slave units listen to other master units. At the end of this period, piconets 42 would reestablish and slaves would communicate any other masters discovered to all their masters. Since the inquiry and discovery intervals are synchronous amongst all masters and slaves, the entire synchronizing event need only take 50 milliseconds to scan the range of 79 hopping frequencies in the U.S. system.

The five intervals in each second can further be divided into time slots for each individual transceiver system 20 in a given piconet 42. This permits each slave to transmit to the master and each master to broadcast to the slave units. In each of the five sections, a slave may switch to a master, a master may switch to a slave, or a slave may switch to a new piconet 42. This allows cross communication between piconet 42 to maintain scatternet 40 while avoiding synchronization overhead normally associated with piconet switching.

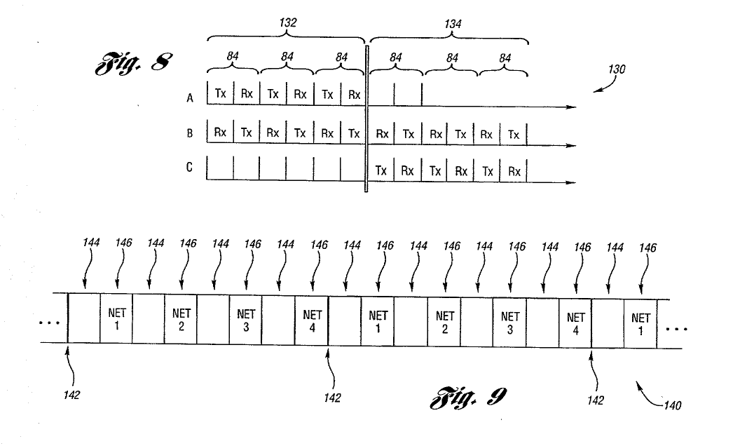

Referring now to FIG. 7, a timing diagram illustrating transceiver discovery according to an embodiment of the present invention is shown. Receiver timing plot 110 illustrates relatively brief listen period 112 for receiving transceiver 22. Because there is no clock offset between receiving transceiver 22 and transmitting transceiver 22 an unburdened transmitter can expect to immediately hit listen period 112 of any receiving transceiver 22 as illustrated in unburdened transmitter timing plot 114. An important implication of synchronizing transmitting and receiving transceivers 22 is illustrated in burdened transmitter timing plot 116. Inquiry scan time 118 can now be narrowed to substantially the same as listen period 112 since transmitting transceiver 22 knows precisely when receiving transceiver 22 is listening.

Referring now to FIG. 8, a timing diagram illustrating piconet switching according to an embodiment of the present invention is shown. As illustrated in timing plot 130, transceivers A, B are communicating in a first piconet 42 during time period 132. Transceiver B communicates with transceiver C in a second piconet 42 during time interval 134. Because transceivers A, B and C are synchronized by PPS signal 104, transceiver B synchronously switches between first piconet 42 and second piconet 42 without the need for any substantial synchronization time 86.

Referring now to FIG. 9, a timing diagram illustrating piconet time division multiplexing according to the embodiment of the invention is shown. As illustrate in timing plot 140, PPS signal 104 may be used to time multiplex non-inquiry activities with inquiry activities. Each repetitive period begins with PPS pulse 142. Each time period is divided into alternating inquiry periods 144 and piconet communication periods 146. Each piconet communication period 146 is dedicated to communicating with a different piconet 42. In the example shown, one half of each period is devoted to searching for other transceivers 22. The remaining portion of each period is divided between four piconets 42. Any number of piconets may be used provided transceiver systems 20 agree to the number.

While the best mode for carrying out the invention has been described in detail, those familiar with the art to which this invention relates will recognize various alternative designs and embodiments for practicing the invention as defined by the following claims. For example, whereas the Bluetooth specification has been used to illustrate an embodiment of the present invention, any frequency hopping specification may be used. Also, different global positioning systems may be used to generate common synchronization signals within the spirit and scope of the present invention.

1. A communication system for an automotive vehicle comprising:
a global positioning satellite (GPS) receiver generating a pulse per second (PPS) signal;
a frequency hopping spread spectrum (FHSS) transceiver in communication with the GPS receiver, the FHSS transceiver communicating with a plurality of FHSS transceivers in other automotive vehicles; and
control logic in communication with the FHSS transceiver and the GPS receiver, the control logic operative to synchronize discovery of at least one of the plurality of FHSS transceivers in the other automotive vehicles based on the PPS signal.

2. A communication system for an automotive vehicle as in claim 1 wherein the control logic forms a first piconet with a first subset of the plurality of FHSS transceivers in other automotive vehicles and a second piconet with a second subset of the plurality of FHSS transceivers in other automotive vehicles.

3. A communication system for an automotive vehicle as in claim 2 wherein the control logic synchronously switches between communicating in the first piconet and communicating in the second piconet based on the PPS signal.

4. A communication system for an automotive vehicle as in claim 1 wherein the FHSS transceiver is a Bluetooth transceiver.

5. A method of communication between automotive vehicles comprising:
receiving in each of a plurality of vehicles global positioning satellite signals from a plurality of global positioning satellites;
determining a pulse per second (PPS) signal in each of the plurality of vehicles based on the global positioning satellite signals;
determining, in at least one of the plurality of vehicles, a frequency hopping pattern for transmitting inquiry packets;
transmitting inquiry packets from the at least one vehicle based on the determined frequency hopping pattern and on the PPS signal;
listening for inquiry packets in at least one of the plurality of vehicles at a plurality of discovery times, each discovery time based on the PPS signal; and
establishing a network between the at least one vehicle transmitting inquiry packets and at least one vehicle listening for inquiry packets if the at least one vehicle listening for inquiry packets receives an inquiry packet from the at least one vehicle transmitting inquiry packets.

6. A method of communication between automotive vehicles as in claim 5 wherein at least one vehicle of the plurality of vehicles participates in a first network and a second network, the first network operating concurrently with the second network.

7. A method of communication between automotive vehicles as in claim 6 further comprising synchronously switching between communicating in the first network and communicating in the second network based on the PPS signal.

8. A method of communication between automotive vehicles as in claim 5 wherein determining a frequency hopping pattern, transmitting inquiry packets, listening for inquiry packets, and establishing a network are based on a Bluetooth standard.

9. An automotive communication system for communicating information between a plurality of automotive vehicles comprising at least one scatternet, each scatternet comprising a plurality of piconets, each piconet comprising at least one vehicle, each vehicle in the automotive communication system comprising a frequency hopping spread spectrum (FHSS) transceiver receiving a synchronizing pulse per second (PPS) signal derived from a global positioning system, whereby each FHSS transceiver in the automotive communication system is synchronized with every other FHSS transceiver in the automotive communication system by the PPS signal.

10. An automotive communication system as in claim 9 wherein each FHSS transceiver is a Bluetooth transceiver.

11. An automotive communication system as in claim 9 wherein each piconet is formed by vehicles transmitting and receiving inquiry packets at a plurality of inquiry times, each inquiry time based on the PPS signal.

12. An automotive communication system as in claim 9 wherein at least one FHSS transceiver is participating in a plurality of piconets, the at least one FHSS transceiver synchronously switching between each piconet in the plurality of piconets based on the PPS signal.
